(19) United States
(12) Patent Application Publication
(10) Pub. No.: US 2024/0344694 A1
(43) Pub. Date: Oct. 17, 2024

(54) OXYGEN GENERATOR WITH OXYGEN-PRODUCING COLUMN HAVING CENTER BORE

(71) Applicant: HUBEI INSTITUTE OF AEROSPACE CHEMICAL TECHNOLOGY, Xiangyang City (CN)

(72) Inventors: Tongfeng Niu, Xiangyang City (CN); Yi Zhang, Xiangyang City (CN); Peng Huang, Xiangyang City (CN); Menglei Wang, Xiangyang City (CN); Jun Gao, Xiangyang City (CN); Mengxia Wang, Xiangyang City (CN); Hongyu Su, Xiangyang City (CN); Weiwei Yu, Xiangyang City (CN); Shiyun Pan, Xiangyang City (CN); Tianwei Zhang, Xiangyang City (CN); Wenlong Zhang, Xiangyang City (CN)

(73) Assignee: HUBEI INSTITUTE OF AEROSPACE CHEMICAL TECHNOLOGY, Xiangyang City (CN)

(21) Appl. No.: 18/756,735

(22) Filed: Jun. 27, 2024

(30) Foreign Application Priority Data
Oct. 30, 2023 (CN) CN202311437517.2

(51) Int. Cl. F23D 1/00; C01B 13/02; F23D 99/00

(52) U.S. Cl. CPC F23D 1/00; C01B 13/02; F23D 91/00; F23D 2207/00; F23D 2212/103

(57) ABSTRACT

An oxygen generator with an oxygen-producing having a center bore, including: an impact-activated ignition mechanism, an end cover, a cylinder, a bell-shaped hood, a thermally insulating inner cylinder, an oxygen-producing column, a thermally insulating material, a support bowl, a gas purification material, a safety valve, an isolation net, an oxygen-discharging end cover and an oxygen-discharging joint. The cylinder is provided with the end cover at one end; the impact-activated ignition mechanism is fixed on the end cover; the oxygen-producing column is coaxially located with the cylinder, one end of the oxygen-producing column is connected to the impact-activated ignition mechanism, and the other end of the oxygen-producing column is connected to the support bowl; the support bowl is connected to the isolation net; the thermally insulating inner cylinder is arranged on the outside of the oxygen-producing column and the thermally insulating material.

### CROSS-REFERENCE TO RELATED APPLICATION

This application claims priority to Chinese Patent Application No. 202311437517.2, filed on Oct. 30, 2023 before the China National Intellectual Property Administration, the disclosure of which is incorporated herein by reference in entirety.

### TECHNICAL FIELD

The present disclosure relates to the field of respiratory equipment, and in particular, to an oxygen generator with an oxygen-producing column having a center bore.

### BACKGROUND

Solid oxygen generator is a chemical oxygen production device. After being percussively activated or electrically activated, the solid oxygen-containing substance undergoes a continuous decomposition reaction, thereby stably producing oxygen. Since the oxygen production process is similar to candle burning, it is also called “oxygen candle”. The solid oxygen generator is small in size, large in oxygen storage capacity, light in weight, safe and reliable, and it can be stored for a long time and easy to use, therefore it can be used as a regular or emergency oxygen source for personnel breathing in confined spaces, and can be used in aviation, aerospace, ships, coal mines, plateaus, parachuting, medical care, and so on.

The oxygen-producing column used in the solid oxygen generator is prepared by processes of dry mixing-wet mixing-pressing-drying. Because the oxygen-producing column after pressing has a high density and it is solid, it is difficult to completely dry the moisture inside the oxygen-producing column. Moisture is an unfavorable component of the oxygen-producing column. Firstly, it adversely affects the stable decomposition of the oxygen-producing column, resulting in fluctuations in the produced oxygen flow rate; secondly, moisture will cause certain side reactions and thereby increase the content of impurity gases; and thirdly, moisture can cause the CO catalytic material to fail and reduce its catalytic efficiency.

During the gradual reaction of the oxygen-producing column, the high-temperature oxygen generated can preheat the subsequent unreacted column, which is conducive to the stable and continuous decomposition of the oxygen-producing column. Since the oxygen-producing column is solid, the high-temperature airflow can only preheat the oxygen-producing column by means of the outside of the column, but cannot fully preheat the internal agent of the column, thereby affecting the oxygen production stability of the oxygen-producing column. This phenomenon is more obvious in a low-temperature environment.

Providing an oxygen generator that can ensure the oxygen production stability of the oxygen-producing column is an urgent problem to be solved in this field.

### SUMMARY

In order to achieve the purpose of the present disclosure, there is provided an oxygen generator with an oxygen-producing having a center bore, comprising: an impact-activated ignition mechanism, an end cover, a cylinder, a bell-shaped hood, a thermally insulating inner cylinder, an oxygen-producing column, a thermally insulating material, a support bowl, a gas purification material, a safety valve, an isolation net, an oxygen-discharging end cover and an oxygen-discharging joint;
the cylinder is provided with the end cover at one end;
the impact-activated ignition mechanism is fixed on the end cover;
the oxygen-producing column is coaxially located with the cylinder, one end of the oxygen-producing column is connected to the impact-activated ignition mechanism, and the other end of the oxygen-producing column is connected to the support bowl;
the support bowl is connected to the isolation net and configured for preventing generated impurities from passing through the oxygen-discharging end cover;
the thermally insulating inner cylinder is arranged on the outside of the oxygen-producing column and the thermally insulating material, and configured for reducing heat generated by the oxygen-producing column from being transferred to an external environment;
the bell-shaped hood is configured to cover a connection of the oxygen-producing column and the impact-activated ignition mechanism;
the support bowl is arranged at a rear end of the oxygen-producing column, and filled therein with the gas purification material;
the oxygen-discharging end cover is arranged at a rear end of the gas purification material;
the oxygen-discharging joint is arranged on the oxygen-discharging end cover;
the safety valve is arranged on the oxygen-discharging end cover.

According to some embodiments of the present disclosure, the impact-activated ignition mechanism comprises an activation pin, a spring, a striker, and a fire cap;
before the impact-activated ignition mechanism works, the activation pin is inserted into the striker to play a role of fixing and limiting, and the spring is in a compressed state; in order to activate the impact-activated ignition mechanism, the activation pin is pulled out, the spring releases compressed internal energy, and the striker moves under the action of the spring to hit the fire cap, then an agent contained in the fire cap burns after being subjected to an impact force, and a high-temperature flame is generated during burning.

According to some embodiments of the present disclosure, the oxygen-producing column comprises an ignition substance and a gas-producing substance; the ignition substance is arranged in a head part or the center bore of the oxygen-producing column.

According to some embodiments of the present disclosure, the oxygen-producing column is provided with a central through hole for conducting airflow.

According to some embodiments of the present disclosure, the thermally insulating material is a high-temperature resistant and low-thermal-conductivity material for isolating the heat generated by the oxygen-producing column from being transferred to the external environment.

According to some embodiments of the present disclosure, the support bowl is peripherally and centrally provided with airflow holes, to allow the gas generated by the oxygen-producing column to flow into the gas purification material through the airflow holes.

According to some embodiments of the present disclosure, the thermally insulating inner cylinder is provided with thermally insulating inner cylinder airflow holes at a bottom thereof, to allow the gas generated by the oxygen-producing column to flow out through the thermally insulating inner cylinder airflow holes.

According to some embodiments of the present disclosure, the thermally insulating material is coated around the oxygen-producing column or in the center bore of the oxygen-producing column, and the thermally insulating material is a high-temperature resistant and low-thermal-conductivity material, and the thermally insulating material is configured for reducing the heat generated by the oxygen-producing column from being transferred to the external environment.

According to some embodiments of the present disclosure, the thermally insulating material is ceramic fiber cotton.

According to some embodiments of the present disclosure, when a gas pressure inside the oxygen generator is greater than an opening pressure of the safety valve, the safety valve is opened, and the gas is discharged from the safety valve; when the gas pressure inside the oxygen generator is lower than the opening pressure of the safety valve, the safety valve is closed, and the gas cannot be discharged from the safety valve.

In the oxygen generator of the present application, the oxygen-producing column is provided with a center bore. The oxygen-producing column provided with a center bore is more conducive to drying, thereby reducing the moisture content in the oxygen-producing column, and thereby improving the oxygen production stability and gas purity of the oxygen generator. The center bore can function in conducting high-temperature airflow, fully preheat the subsequent unreacted agent, and further improve the oxygen production stability and low-temperature environment adaptability of the oxygen generator. Thus, compared with the existing oxygen generator using solid oxygen-producing column, the oxygen generator of the present disclosure has a more stable reaction, higher gas purity, and better adaptability to low-temperature environment.

In addition, the ignition substance can be arranged in the center bore of the oxygen-producing column, which can effectively increase the reaction cross-sectional area of the oxygen-producing column, greatly improve the oxygen production speed. Thus, the solid oxygen generator can be applied to occasions with needs for a high oxygen flow rate.

### BRIEF DESCRIPTION OF THE DRAWINGS

In order to more clearly illustrate the embodiments of the present application, the drawings are briefly introduced below. Obviously, the following drawings only represent some embodiments of the present application, and other drawings may be obtained by those skilled in the art based on the following drawings without creative work.

FIG. 1 is a schematic structural view of an oxygen generator;

FIG. 2 is a schematic structural view of a support bowl of an oxygen generator;

FIG. 3 is a schematic structural view of an oxygen generator with an oxygen-producing column having a center bore in the first embodiment of the present disclosure;

FIG. 4 is a schematic structural view of an oxygen generator with an oxygen-producing column having a center bore in the second embodiment of the present disclosure;

FIG. 5 is a schematic structural view of a support bowl of an oxygen generator with an oxygen-producing column having a center bore in the second embodiment of the present disclosure;

FIG. 6 is a schematic structural view of an oxygen generator with an oxygen-producing column having a center bore in the third embodiment of the present disclosure.

### DETAILED DESCRIPTION OF EMBODIMENTS

Next, the embodiments of the present disclosure will be clearly and completely described with reference to the accompanying drawings. Obviously, the described embodiments are only part of the present disclosure, but do not represent all the present disclosure.

Examples of the embodiments are shown in the accompanying drawings, where the same or similar reference numerals throughout the present disclosure represent the same or similar elements or the elements with the same or similar functions. The embodiments described below with reference to the accompanying drawings are exemplary and are intended to be used to explain the present disclosure, but should not be understood as limiting the present disclosure.

### Embodiment 1

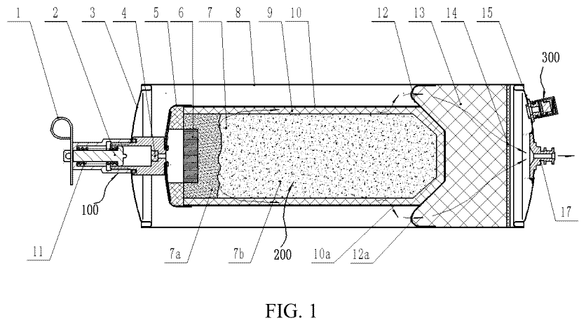

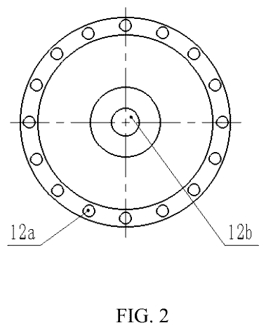

This embodiment provides an oxygen generator with an oxygen-producing column having a center bore, as shown in FIGS. 1 to 3, including an impact-activated ignition mechanism 100, an end cover 3, a cylinder 8, a bell-shaped hood 5, a thermally insulating inner cylinder 10, an oxygen-producing column 200, a thermally insulating material 9, a support bowl 12, a gas purification material 13, a safety valve 300, an isolation net 14, an oxygen-discharging end cover 15 and an oxygen-discharging joint 17.

The cylinder 8 is provided with the end cover 3 at one end; the impact-activated ignition mechanism 100 is fixed on the end cover 3; the oxygen-producing column 200 is coaxially located with the cylinder, one end of the oxygen-producing column is connected to the impact-activated ignition mechanism 100, and the other end of the oxygen-producing column is connected to the support bowl 12; the support bowl 12 is connected to the isolation net 14 and configured for preventing generated impurities from passing through the oxygen-discharging end cover 15; the thermally insulating inner cylinder 10 is arranged on the outside of the oxygen-producing column 200 and the thermally insulating material 9, and configured for reducing heat generated by the oxygen-producing column 200 from being transferred to an external environment; the bell-shaped hood 5 is configured to cover a connection of the oxygen-producing column 200 and the impact-activated ignition mechanism 100; the support bowl 12 is arranged at a rear end of the oxygen-producing column 200, and filled therein with the gas purification material 13; the oxygen-discharging end cover 15 is arranged at a rear end of the gas purification material 13; the oxygen-discharging joint 17 is arranged on the oxygen-discharging end cover 15; the safety valve 300 is arranged on the oxygen-discharging end cover 15.

In a specific embodiment of the present disclosure, the impact-activated ignition mechanism 100 comprises a activation pin 1, a spring 11, a striker 2, and a fire cap 4; before the impact-activated ignition mechanism 100 works, the activation pin 1 is inserted into the striker 2 to play a role of fixing and limiting, and the spring 11 is in a compressed state; in order to activate the impact-activated ignition mechanism 100, the activation pin 1 is pulled out, the spring 11 releases compressed internal energy, and the striker 2 moves under the action of the spring 11 to hit the fire cap 4, then an agent contained in the fire cap 4 burns after being subjected to an impact force, and a high-temperature flame is generated during burning.

In a specific embodiment of the present disclosure, the oxygen-producing column 200 comprises an ignition substance 6 and a gas-producing substance 7; the ignition substance 6 is arranged in a head part or the center bore of the oxygen-producing column 200.

In a specific embodiment of the present disclosure, the oxygen-producing column 200 is provided with a central through hole for conducting airflow.

Specifically, the oxygen-producing column 200 is mainly composed of an ignition substance 6 and a gas-producing substance 7, and its formula is shown in Table 1. The ignition substance 6 and the gas-producing substance 7 can undergo a decomposition reaction under high temperature to produce oxygen and heat. The high temperature flame generated by the fire cap 4 can directly ignite the ignition substance 6, and the gas-producing substance 7 continues to decompose under the action of heat, thereby continuously generating oxygen. The oxygen-producing column 200 is provided with a central through hole for conducting airflow. The ignition substance 6 can be arranged at the head part of the oxygen-producing column or in its center bore.

TABLE 1
Typical formula of oxygen-producing column

| | Sodium | Iron | Cobalt | Barium |
|---|---|---|---|---|
| | chlorate | powder | trioxide | peroxide |
| Ignition | 80 | 10 | 8 | 2 |
| substance | | | | |
| Gas- | 90 | 3 | 3 | 4 |
| producing | | | | |
| substance | | | | |

The thermally insulating material 9 is coated around the oxygen-producing column 200 or in the center bore of the oxygen-producing column, and the thermally insulating material is a high-temperature resistant and low-thermal-conductivity material, and the thermally insulating material is configured for reducing the heat generated by the oxygen-producing column 200 from being transferred to the external environment. The thermally insulating material 9 adopts ceramic fiber cotton.

The thermally insulating inner cylinder 10 is arranged outside the oxygen-producing column 200 and the thermally insulating material 9, and configured to reduce the heat generated by the oxygen-producing column 200 from being transferred to the external environment. At the same time, the bottom of the thermally insulating inner cylinder 10 is provided with thermally insulating inner cylinder airflow holes 10a, and the gas produced by the oxygen-producing column can flow out through the thermally insulating inner cylinder airflow holes.

The support bowl 12 is arranged at the rear end of the oxygen-producing column 200, and the periphery of the support bowl is provided with airflow holes 12a. The gas produced by the oxygen-producing column can flow into the gas purification material 13 through the airflow holes 12a of the support bowl.

The gas purification material 13 is arranged at the front end of the gas outlet, and is used to absorb trace impurity gases such as chlorine, carbon monoxide and carbon dioxide in the generated gas. The gas purification material includes an alkaline material or a carbon monoxide catalytic material. The carbon monoxide catalytic material adopts a rod-shaped hopcalite, and the alkaline material adopts a spherical lithium hydroxide.

The oxygen-discharging end cover 15 is arranged at the rear end of the oxygen generator, and the oxygen-discharging joint 17 is arranged on the oxygen-discharging end cover 15, and the oxygen flow can flow out through the oxygen-discharging joint.

The safety valve 300 is arranged on the oxygen-discharging end cover. When the gas pressure inside the oxygen generator is greater than the opening pressure of the safety valve 300, the safety valve 300 opens and the gas can be discharged from the safety valve 300; when the gas pressure inside the oxygen generator is lower than the opening pressure of the safety valve 300, the safety valve 300 closes and the gas cannot be discharged from the safety valve 300.

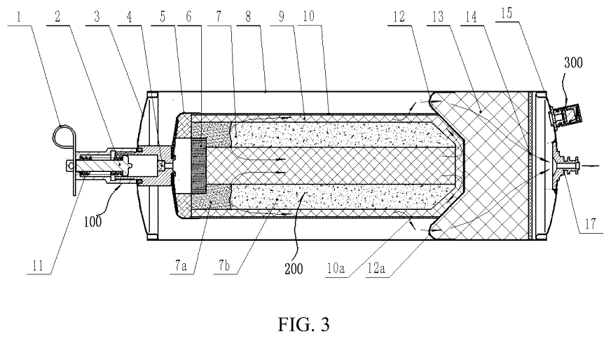

The working principle is: the oxygen-producing column 200 is mainly composed of an ignition substance 6 and a gas-producing substance 7. The ignition substance 6 and the gas-producing substance 7 can undergo a decomposition reaction under high temperature to produce oxygen and heat. When the impact-activated ignition mechanism 100 is working, the activation pin 1 is pulled out, the spring 11 releases the compressed internal energy, and the striker 2 moves under the action of the spring 11, thereby impacting the fire cap 4. The internal agent in the fire cap 4 burns after being impacted, and a high-temperature flame can be generated during combustion. The high-temperature flame generated by the fire cap 4 can directly ignite the ignition substance 6, and the gas-producing substance 7 continues to decompose under the action of heat. The generated gas flows through the outer side and the center bore of the oxygen-producing column at the same time, fully preheating the subsequent unreacted oxygen-producing column 7b. The gas-producing substance 7 burns along the axial end face, thereby continuously generating oxygen. The airflow flows into the gas purification material 13 through the thermally insulating inner cylinder airflow holes 10a and the airflow holes 12a of the support bowl in turn, and then flows out after the impurity gas is absorbed by the gas purification material 13. The airflow direction is shown by the arrow in FIG. 3.

Compared with the existing oxygen generator, the oxygen-producing column of this embodiment has a center bore. During the reaction of the oxygen-producing column, the airflow can simultaneously preheat the inside and outside of the unreacted oxygen-producing column 7b. The preheating is more sufficient than that of the solid column, further improving the oxygen production stability and low-temperature environment adaptability of the oxygen generator.

### Embodiment 2

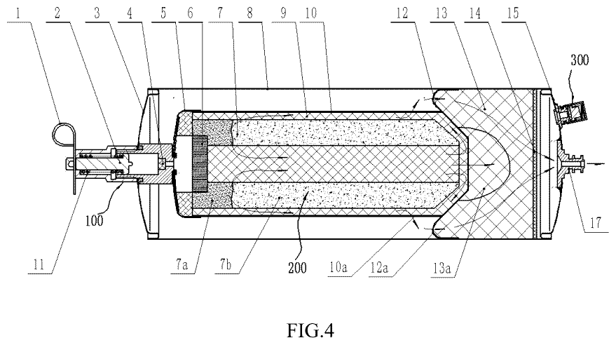

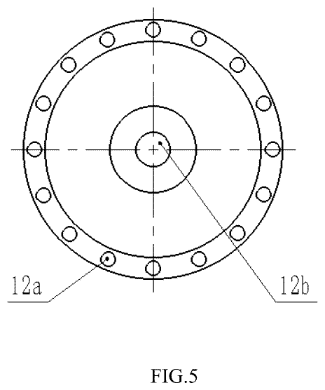

This embodiment provides an oxygen generator with an oxygen-producing column having a center bore, as shown in FIGS. 4 and 5, including an impact-activated ignition mechanism 100, an end cover 3, a cylinder 8, a bell-shaped hood 5, a thermally insulating inner cylinder 10, an oxygen-producing column 200, a thermally insulating material 9, a support bowl 12, a gas purification material 13, a safety valve 300, an isolation net 14, an oxygen-discharging end cover 15 and an oxygen-discharging joint 17.

The cylinder 8 is provided with the end cover 3 at one end; the impact-activated ignition mechanism 100 is fixed on the end cover 3; the oxygen-producing column 200 is coaxially located with the cylinder, one end of the oxygen-producing column is connected to the impact-activated ignition mechanism 100, and the other end of the oxygen-producing column is connected to the support bowl 12; the support bowl 12 is connected to the isolation net 14 and configured for preventing generated impurities from passing through the oxygen-discharging end cover 15; the thermally insulating inner cylinder 10 is arranged on the outside of the oxygen-producing column 200 and the thermally insulating material 9, and configured for reducing heat generated by the oxygen-producing column 200 from being transferred to an external environment; the bell-shaped hood 5 is configured to cover a connection of the oxygen-producing column 200 and the impact-activated ignition mechanism 100; the support bowl 12 is arranged at a rear end of the oxygen-producing column 200, and filled therein with the gas purification material 13; the oxygen-discharging end cover 15 is arranged at a rear end of the gas purification material 13; the oxygen-discharging joint 17 is arranged on the oxygen-discharging end cover 15; the safety valve 300 is arranged on the oxygen-discharging end cover 15.

In a specific embodiment of the present disclosure, the impact-activated ignition mechanism 100 comprises a activation pin 1, a spring 11, a striker 2, and a fire cap 4; before the impact-activated ignition mechanism 100 works, the activation pin 1 is inserted into the striker 2 to play a role of fixing and limiting, and the spring 11 is in a compressed state; in order to activate the impact-activated ignition mechanism 100, the activation pin 1 is pulled out, the spring 11 releases compressed internal energy, and the striker 2 moves under the action of the spring 11 to hit the fire cap 4, then an agent contained in the fire cap 4 burns after being subjected to an impact force, and a high-temperature flame is generated during burning.

In a specific embodiment of the present disclosure, the oxygen-producing column 200 comprises an ignition substance 6 and a gas-producing substance 7; the ignition substance 6 is arranged in a head part or the center bore of the oxygen-producing column 200.

In a specific embodiment of the present disclosure, the oxygen-producing column 200 is provided with a central through hole for conducting airflow.

Specifically, the oxygen-producing column 200 is mainly composed of an ignition substance 6 and a gas-producing substance 7, and its formula is shown in Table 2. The ignition substance 6 and the gas-producing substance 7 can undergo a decomposition reaction under high temperature to produce oxygen and heat. The high temperature flame generated by the fire cap 4 can directly ignite the ignition substance 6, and the gas-producing substance 7 continues to decompose under the action of heat, thereby continuously generating oxygen. The oxygen-producing column 200 is provided with a central through hole for conducting airflow. The ignition substance 6 can be arranged at the head part of the oxygen-producing column.

TABLE 2
Typical formula of oxygen-producing column

| | Sodium | Iron | Cobalt | Barium |
|---|---|---|---|---|
| | chlorate | powder | trioxide | peroxide |
| Ignition | 80 | 10 | 8 | 2 |
| substance | | | | |
| Gas- | 90 | 3 | 3 | 4 |
| producing | | | | |
| substance | | | | |

The thermally insulating material 9 is coated around the oxygen-producing column 200 or in the center bore of the oxygen-producing column, and the thermally insulating material is a high-temperature resistant and low-thermal-conductivity material, and the thermally insulating material is configured for reducing the heat generated by the oxygen-producing column 200 from being transferred to the external environment. The thermally insulating material 9 adopts ceramic fiber cotton.

The thermally insulating inner cylinder 10 is arranged outside the oxygen-producing column 200 and the thermally insulating material 9, and configured to reduce the heat generated by the oxygen-producing column 200 from being transferred to the external environment. At the same time, the bottom of the thermally insulating inner cylinder 10 is provided with thermally insulating inner cylinder airflow holes 10a, and the gas produced by the oxygen-producing column can flow out through the thermally insulating inner cylinder airflow holes.

The support bowl 12 is arranged at the rear end of the oxygen-producing column 200, and the periphery and the center of the support bowl is provided with airflow holes 12a and airflow holes 12b. The gas produced by the oxygen-producing column can flow into the gas purification material 13 through the airflow holes 12a and airflow holes 12b of the support bowl, its structure is shown in FIG. 5.

The gas purification material 13 is arranged at the front end of the gas outlet, and is used to absorb trace impurity gases such as chlorine, carbon monoxide and carbon dioxide in the generated gas. The gas purification material includes an alkaline material or a carbon monoxide catalytic material. The carbon monoxide catalytic material adopts a rod-shaped hopcalite, and the alkaline material adopts a spherical lithium hydroxide.

The oxygen-discharging end cover 15 is arranged at the rear end of the oxygen generator, and the oxygen-discharging joint 17 is arranged on the oxygen-discharging end cover 15, and the oxygen flow can flow out through the oxygen-discharging joint.

The safety valve 300 is arranged on the oxygen-discharging end cover. When the gas pressure inside the oxygen generator is greater than the opening pressure of the safety valve 300, the safety valve 300 opens and the gas can be discharged from the safety valve 300; when the gas pressure inside the oxygen generator is lower than the opening pressure of the safety valve 300, the safety valve 300 closes and the gas cannot be discharged from the safety valve 300.

The working principle is: the oxygen-producing column 200 is mainly composed of an ignition substance 6 and a gas-producing substance 7. The ignition substance 6 and the gas-producing substance 7 can undergo a decomposition reaction under high temperature to produce oxygen and heat. When the impact-activated ignition mechanism 100 is working, the activation pin 1 is pulled out, the spring 11 releases the compressed internal energy, and the striker 2 moves under the action of the spring 11, thereby impacting the fire cap 4. The internal agent in the fire cap 4 burns after being impacted, and a high-temperature flame can be generated during combustion. The high-temperature flame generated by the fire cap 4 can directly ignite the ignition substance 6, and the gas-producing substance 7 continues to decompose under the action of heat. The generated gas flows through the outer side and the center bore of the oxygen-producing column 200 at the same time, fully preheating the subsequent unreacted oxygen-producing column 7b. The gas-producing substance 7 burns along the axial end face, thereby continuously generating oxygen. The airflow flows into the gas purification material 13 through the thermally insulating inner cylinder airflow holes 10a and the airflow holes 12a, 12b of the support bowl in turn, and then flows out after the impurity gas is absorbed by the gas purification material 13. The airflow direction is shown by the arrow in FIG. 4.

Compared with the embodiment 1, the support bowl 12 in this embodiment is provided with airflow holes 12a and 12b at the periphery and center at the same time. The gas generated by the oxygen-producing column 200 can flow into the gas purification material 13 through the airflow holes 12a and 12b of the support bowl at the same time, it can effectively improve the utilization rate of the gas purification material 13a in the airflow dead zone, thereby improving the overall utilization rate of the gas purification material 13, and at the same time it can reduce the use of the gas purification material and the overall volume and weight of the oxygen generator.

### Embodiment 3

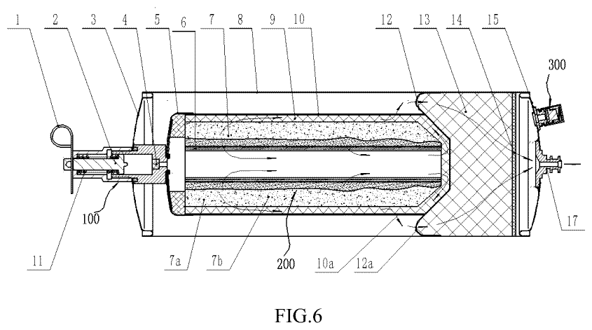

This embodiment provides an oxygen generator with an oxygen-producing column having a center bore, as shown in FIG. 6, including an impact-activated ignition mechanism 100, an end cover 3, a cylinder 8, a bell-shaped hood 5, a thermally insulating inner cylinder 10, an oxygen-producing column 200, a thermally insulating material 9, a support bowl 12, a gas purification material 13, a safety valve 300, an isolation net 14, an oxygen-discharging end cover 15 and an oxygen-discharging joint 17.

The cylinder 8 is provided with the end cover 3 at one end; the impact-activated ignition mechanism 100 is fixed on the end cover 3; the oxygen-producing column 200 is coaxially located with the cylinder, one end of the oxygen-producing column is connected to the impact-activated ignition mechanism 100, and the other end of the oxygen-producing column is connected to the support bowl 12; the support bowl 12 is connected to the isolation net 14 and configured for preventing generated impurities from passing through the oxygen-discharging end cover 15; the thermally insulating inner cylinder 10 is arranged on the outside of the oxygen-producing column 200 and the thermally insulating material 9, and configured for reducing heat generated by the oxygen-producing column 200 from being transferred to an external environment; the bell-shaped hood 5 is configured to cover a connection of the oxygen-producing column 200 and the impact-activated ignition mechanism 100; the support bowl 12 is arranged at a rear end of the oxygen-producing column 200, and filled therein with the gas purification material 13; the oxygen-discharging end cover 15 is arranged at a rear end of the gas purification material 13; the oxygen-discharging joint 17 is arranged on the oxygen-discharging end cover 15; the safety valve 300 is arranged on the oxygen-discharging end cover 15.

In a specific embodiment of the present disclosure, the impact-activated ignition mechanism 100 comprises a activation pin 1, a spring 11, a striker 2, and a fire cap 4; before the impact-activated ignition mechanism 100 works, the activation pin 1 is inserted into the striker 2 to play a role of fixing and limiting, and the spring 11 is in a compressed state; in order to activate the impact-activated ignition mechanism 100, the activation pin 1 is pulled out, the spring 11 releases compressed internal energy, and the striker 2 moves under the action of the spring 11 to hit the fire cap 4, then an agent contained in the fire cap 4 burns after being subjected to an impact force, and a high-temperature flame is generated during burning.

In a specific embodiment of the present disclosure, the oxygen-producing column 200 comprises an ignition substance 6 and a gas-producing substance 7; the ignition substance 6 is arranged in a head part or the center bore of the oxygen-producing column 200.

In a specific embodiment of the present disclosure, the oxygen-producing column 200 is provided with a central through hole for conducting airflow.

Specifically, the oxygen-producing column 200 is mainly composed of an ignition substance 6 and a gas-producing substance 7, and its formula is shown in Table 3. The ignition substance 6 and the gas-producing substance 7 can undergo a decomposition reaction under high temperature to produce oxygen and heat. The high temperature flame generated by the fire cap 4 can directly ignite the ignition substance 6, and the gas-producing substance 7 continues to decompose under the action of heat, thereby continuously generating oxygen. The oxygen-producing column 200 is provided with a central through hole for conducting airflow. The ignition substance 6 can be arranged at the center bore of the oxygen-producing column 200.

TABLE 3
Typical formula of oxygen-producing column

| | Sodium | Iron | Cobalt | Barium |
|---|---|---|---|---|
| | chlorate | powder | trioxide | peroxide |
| Ignition | 80 | 10 | 8 | 2 |
| substance | | | | |
| Gas- | 90 | 3 | 3 | 4 |
| producing | | | | |
| substance | | | | |

The thermally insulating material 9 is coated around the oxygen-producing column 200, and there is no thermally insulating material 9 in the center bore of the oxygen-producing column, and the thermally insulating material is a high-temperature resistant and low-thermal-conductivity material, and the thermally insulating material is configured for reducing the heat generated by the oxygen-producing column 200 from being transferred to the external environment. The thermally insulating material 9 adopts ceramic fiber cotton.

The thermally insulating inner cylinder 10 is arranged outside the oxygen-producing column 200 and the thermally insulating material 9, and configured to reduce the heat generated by the oxygen-producing column 200 from being transferred to the external environment. At the same time, the bottom of the thermally insulating inner cylinder 10 is provided with thermally insulating inner cylinder airflow holes 10a, and the gas produced by the oxygen-producing column can flow out through the thermally insulating inner cylinder airflow holes.

The support bowl 12 is arranged at the rear end of the oxygen-producing column 200, and the periphery of the support bowl is provided with airflow holes 12a. The gas produced by the oxygen-producing column can flow into the gas purification material 13 through the airflow holes 12a of the support bowl.

The gas purification material 13 is arranged at the front end of the gas outlet, and is used to absorb trace impurity gases such as chlorine, carbon monoxide and carbon dioxide in the generated gas. The gas purification material includes an alkaline material or a carbon monoxide catalytic material. The carbon monoxide catalytic material adopts a rod-shaped hopcalite, and the alkaline material adopts a spherical lithium hydroxide.

The oxygen-discharging end cover 15 is arranged at the rear end of the oxygen generator, and the oxygen-discharging joint 17 is arranged on the oxygen-discharging end cover 15, and the oxygen flow can flow out through the oxygen-discharging joint.

The safety valve 300 is arranged on the oxygen-discharging end cover. When the gas pressure inside the oxygen generator is greater than the opening pressure of the safety valve 300, the safety valve 300 opens and the gas can be discharged from the safety valve 300; when the gas pressure inside the oxygen generator is lower than the opening pressure of the safety valve 300, the safety valve 300 closes and the gas cannot be discharged from the safety valve 300.

The working principle is: the oxygen-producing column 200 is mainly composed of an ignition substance 6 and a gas-producing substance 7. The ignition substance 6 and the gas-producing substance 7 can undergo a decomposition reaction under high temperature to produce oxygen and heat. When the impact-activated ignition mechanism 100 is working, the activation pin 1 is pulled out, the spring 11 releases the compressed internal energy, and the striker 2 moves under the action of the spring 11, thereby impacting the fire cap 4. The internal agent in the fire cap 4 burns after being impacted, and a high-temperature flame can be generated during combustion. The high-temperature flame generated by the fire cap 4 can directly ignite the ignition substance 6, and the gas-producing substance 7 continues to decompose under the action of heat. The generated gas flows through the outer side and the center bore of the oxygen-producing column 200 at the same time, fully preheating the subsequent unreacted oxygen-producing column 7b, thereby continuously generating oxygen. The airflow flows into the gas purification material 13 through the thermally insulating inner cylinder airflow holes 10a and the airflow holes 12a of the support bowl in turn, and then flows out after the impurity gas is absorbed by the gas purification material 13. The airflow direction is shown by the arrow in FIG. 6.

Compared with the embodiment 1 and the embodiment 2, the ignition substance 6 of this embodiment is arranged in the center bore of the oxygen-producing column 200, and the thermally insulating material 9 is not filled in the center bore of the oxygen-producing column. After the fire cap 4 works, it can quickly ignite the ignition substance 6 in the center bore, and then ignite the gas-producing substance 7. The gas-producing substance 7 decomposes along the radial direction, and the reaction cross-sectional area is greatly increased, it can achieve a higher oxygen production speed, so that the solid oxygen generator can be applied to occasions with needs for a high oxygen flow rate.

The method and device provided by the present disclosure are described in detail above. The principle and implementation method of the present disclosure are described in this application with reference to specific examples, to help understand the method and its core idea of the present disclosure. For those skilled in the art, there will be changes in the specific implementation method and application scope according to the idea of the present disclosure. The content of this specification should not be understood as limiting the present disclosure.

In the description of this specification, the reference terms, such as “one embodiment”, “some embodiments”, “example”, “specific example”, “one specific embodiment” or “some examples”, mean that the specific features, structures, materials or characteristics described in conjunction with the embodiment or example are included in at least one embodiment or example of the present disclosure. In this specification, the schematic representation of the terms does not necessarily refer to the same embodiment or example. Moreover, the specific features, structures, materials or characteristics described can be incorporated in any one or more embodiments or examples in a suitable manner.

The above embodiments are only used to illustrate the technical solutions of the present application, rather than to limit them. Although the present application has been described in detail with reference to the aforementioned embodiments, it should be understood by those skilled in the art that modifications can be made to the technical solutions described in the aforementioned embodiments, or equivalent replacements can be made to some of the technical features therein. However, these modifications or replacements do not cause the essence of the corresponding technical solutions to deviate from the spirit and scope of the technical solutions of the embodiments of the present application.

What is claimed is:

1. An oxygen generator with an oxygen-producing having a center bore, comprising: an impact-activated ignition mechanism (100), an end cover (3), a cylinder (8), a bell-shaped hood (5), a thermally insulating inner cylinder (10), an oxygen-producing column (200), a thermally insulating material (9), a support bowl (12), a gas purification material (13), a safety valve (300), an isolation net (14), an oxygen-discharging end cover (15) and an oxygen-discharging joint (17);
the cylinder (8) is provided with the end cover (3) at one end;
the impact-activated ignition mechanism (100) is fixed on the end cover (3);
the oxygen-producing column (200) is coaxially located with the cylinder, one end of the oxygen-producing column is connected to the impact-activated ignition mechanism (100), and the other end of the oxygen-producing column is connected to the support bowl (12);
the support bowl (12) is connected to the isolation net (14) and configured for preventing generated impurities from passing through the oxygen-discharging end cover (15);
the thermally insulating inner cylinder (10) is arranged on the outside of the oxygen-producing column (200) and the thermally insulating material (9), and configured for reducing heat generated by the oxygen-producing column (200) from being transferred to an external environment;
the bell-shaped hood (5) is configured to cover a connection of the oxygen-producing column (200) and the impact-activated ignition mechanism (100);
the support bowl (12) is arranged at a rear end of the oxygen-producing column (200), and filled therein with the gas purification material (13);
the oxygen-discharging end cover (15) is arranged at a rear end of the gas purification material (13);
the oxygen-discharging joint (17) is arranged on the oxygen-discharging end cover (15);
the safety valve (300) is arranged on the oxygen-discharging end cover (15).

2. The oxygen generator according to claim 1, wherein the impact-activated ignition mechanism (100) comprises an activation pin (1), a spring (11), a striker (2), and a fire cap (4);
before the impact-activated ignition mechanism (100) works, the activation pin (1) is inserted into the striker (2) to play a role of fixing and limiting, and the spring (11) is in a compressed state; in order to activate the impact-activated ignition mechanism (100), the activation pin (1) is pulled out, the spring (11) releases compressed internal energy, and the striker (2) moves under the action of the spring (11) to hit the fire cap (4), then an agent contained in the fire cap (4) burns after being subjected to an impact force, and a high-temperature flame is generated during burning.

3. The oxygen generator according to claim 1, wherein the oxygen-producing column (200) comprises an ignition substance (6) and a gas-producing substance (7); the ignition substance (6) is arranged in a head part or the center bore of the oxygen-producing column (200).

4. The oxygen generator according to claim 3, wherein the oxygen-producing column (200) is provided with a central through hole for conducting airflow.

5. The oxygen generator according to claim 1, wherein the thermally insulating material (9) is a high-temperature resistant and low-thermal-conductivity material for isolating the heat generated by the oxygen-producing column (200) from being transferred to the external environment.

6. The oxygen generator according to claim 1, wherein the support bowl (12) is peripherally and centrally provided with airflow holes, to allow the gas generated by the oxygen-producing column (200) to flow into the gas purification material (13) through the airflow holes.

7. The oxygen generator according to claim 1, wherein the thermally insulating inner cylinder (10) is provided with thermally insulating inner cylinder airflow holes (10a) at a bottom thereof, to allow the gas generated by the oxygen-producing column (200) to flow out through the thermally insulating inner cylinder airflow holes.

8. The oxygen generator according to claim 1, wherein the thermally insulating material (9) is coated around the oxygen-producing column (200) or in the center bore of the oxygen-producing column, and the thermally insulating material is a high-temperature resistant and low-thermal-conductivity material, and the thermally insulating material is configured for reducing the heat generated by the oxygen-producing column (200) from being transferred to the external environment.

9. The oxygen generator according to claim 8, wherein the thermally insulating material (9) is ceramic fiber cotton.

10. The oxygen generator according to claim 1, wherein when a gas pressure inside the oxygen generator is greater than an opening pressure of the safety valve (300), the safety valve (300) is opened, and the gas is discharged from the safety valve (300); when the gas pressure inside the oxygen generator is lower than the opening pressure of the safety valve (300), the safety valve (300) is closed, and the gas cannot be discharged from the safety valve (300).
